(19) United States
(12) Patent Application Publication
(10) Pub. No.: US 2011/0307926 A1
(43) Pub. Date: Dec. 15, 2011

(54) SYSTEM ON CHIP AND METHOD FOR DISPLAYING A GRAPHICAL USER INTERFACE IN A VIDEO

(75) Inventors: KUO TIENCHIEH, Tu-Cheng (TW); CHING-WEI HO, Tu-Cheng (TW)

(73) Assignee: HON HAI PRECISION INDUSTRY CO., LTD., Tu-Cheng (TW)

(21) Appl. No.: 12/900,469

(22) Filed: Oct. 7, 2010

(30) Foreign Application Priority Data
Jun. 9, 2010 (TW) 99118736

(51) Int. Cl. H04N 5/445

(52) U.S. Cl. 725/49

(57) ABSTRACT

A system on chip (SOC) and method displays a graphical user interface (GUI) in a video. The SOC receives a video from the video input device and a GUI from the GUI circuit, and saves the video into a first frame buffer of the SOC and the GUI into a second frame buffer in the SOC. A combined video is generated by combining the video from the first frame buffer and the GUI from the second frame buffer and sent to the display device to display the combined video.

### BACKGROUND

1. Technical Field

Embodiments of the present disclosure relate to display technology, and particularly to a system on chip (SOC) and method for displaying a graphical user interface (GUI) in a video.

2. Description of Related Art

System-on-a-chip or system on chip (SoC or SOC) refers to integrating all components of a computer or other electronic systems into a single integrated circuit chip, such as, an embedded system, or a central processing unit (CPU).

A graphical user interface (GUI) offers graphical icons, and visual indicators, as opposed to text-based interfaces, typed command labels or text navigation to fully represent the information and actions available to a user, such as, an on-screen display (OSD).

The GUI is often generated by the SOC. However, the SOC may become overextended and not have enough power to properly generate the GUI. If the load of the SOC is heavy, the GUI will be not displayed properly.

### BRIEF DESCRIPTION OF THE DRAWINGS

FIG. 1 is a block diagram of one embodiment of a SOC comprising a GUI displaying system.

FIG. 2 is a flowchart of one embodiment of a method for displaying a GUI in a video.

FIG. 3 illustrates one embodiment of a method of combining the video with the GUI to generate a combined video.

### DETAILED DESCRIPTION

In general, the word “module,” as used herein, refers to logic embodied in hardware or firmware, or to a collection of software instructions, written in a program language. In one embodiment, the program language may be Java or C. One or more software instructions in the modules may be embedded in firmware, such as an EPROM. The modules described herein may be implemented as either software and/or hardware modules and may be stored in any type of computer-readable medium or other storage device.

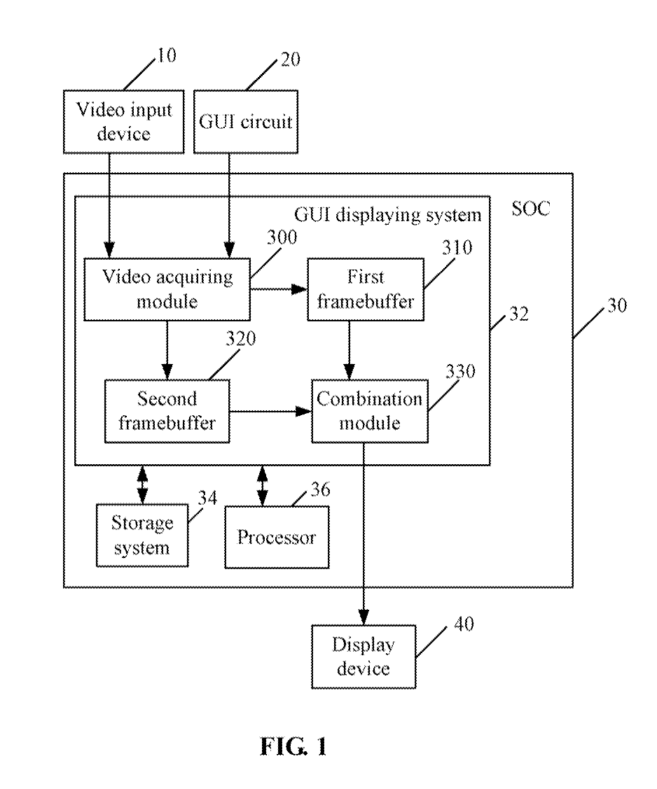

FIG. 1 is a block diagram of one embodiment of a system on chip (SOC) 30 comprising a graphical user interface (GUI) displaying system 32. In one embodiment, the GUI displaying system 32 is used to combine a video and a GUI to generate a combined video. The SOC 30 is connected to a video input device 10, a GUI circuit 20, and a display device 40.

The video input device 10 transfers a video to the SOC 30. In one embodiment, the video input device 10 may be, but are not limited to, a portable media player, a digital versatile disc (DVD) player, a cable television connection, or any other device that can play back videos.

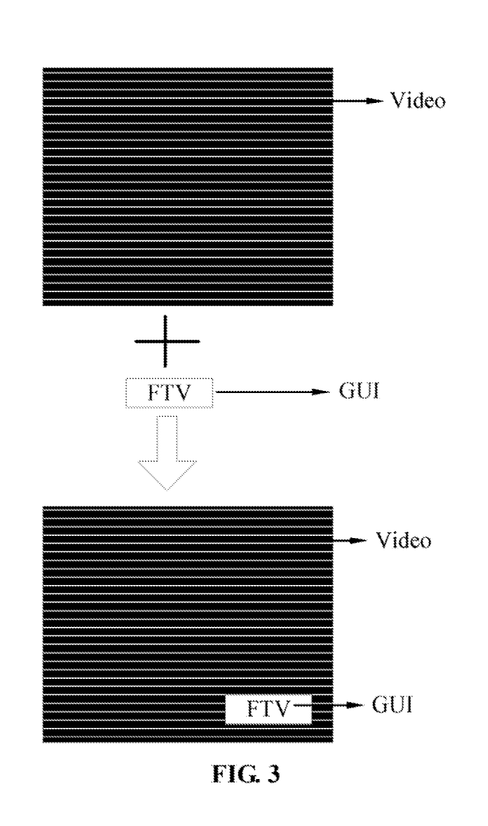

The GUI circuit 20 generates a GUI and sends the generated GUI to the SOC 30. A user can set the GUI in the GUI circuit 20 to display desired characters at the desired position of display device 40. For example, as shown in FIG. 3, a GUI displays the characters “FTV” at the bottom right of the display device 40. In one embodiment, the GUI circuit 20 may be, but is not limited to, an application specific integrated circuit (ASIC), or any other device that can generate GUIs.

The SOC 30 combines the generated video from the video input device 10 and the generated GUI from the GUI circuit 20 to generate the combined video and send the combined video to the display device 40.

The display device 40 displays the combined video. As shown in FIG. 3, the display device 40 displays the combined video which is combined with a video and a GUI. In one embodiment, the display device 40 may be, but is not limited to, a monitor or a television.

In one embodiment, the GUI displaying system 32 includes a video acquiring module 300, a first frame buffer 310, a second frame buffer 320, and a combination module 330. The modules 300-330 may comprise computerized code in the form of one or more programs that are stored in the storage system 34. The computerized code includes instructions that are executed by the at least one processor 36 to provide functions for modules 300-330. The storage system 34 may be, but are not limited to, a memory, a random-access memory (RAM), flash memory, or a cache.

The video acquiring module 300 receives the generated video from the video input device 10 and the generated GUI from the GUI circuit 20, and saves the generated video into the first frame buffer 310 and the generated GUI into the second frame buffer 320. It is understood that the frame buffer is a memory buffer that contains a complete frame of the video.

The combination module 330 combines the video from the first frame buffer 310 and the GUI from the second frame buffer 320 to generate the combined video and sends the combined video to the display device 40. In one embodiment, the combination module 330 uses a method of alpha blending to combine the video and the GUI. For example, the combination module 330 puts the GUI onto the video, as shown in FIG. 3. It is understood that the alpha blending is defined as a process of combining a video with a GUI to create a combined video in the computer graphic technology.

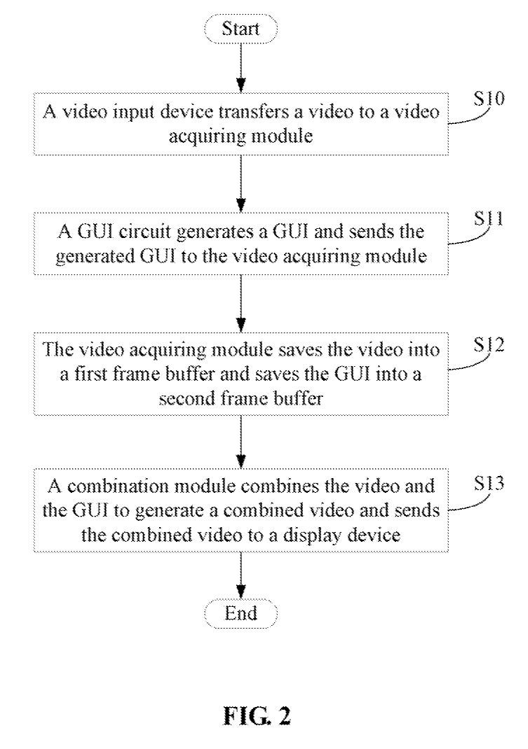

FIG. 2 is a flowchart of one embodiment of a method for displaying a GUI in a video. The method may be used to combine the video and the GUI to generate the combined video. Depending on the embodiment, additional blocks may be added, others deleted, and the ordering of the blocks may be changed.

In block S10, the video acquiring module 300 receives a video from the video input device 10. As mentioned above, the video input device 10 may be, but are not limited to, a portable media player, a DVD player, a blue-ray player, a cable television connection, or any other device that can play back or generate videos.

In block S11, the video acquiring module 300 a GUI from the GUI circuit 20. As mentioned above, the GUI circuit 20 may be, but is not limited to, an ASCI chip.

In block S12, the video acquiring module 300 saves the video into a first frame buffer 310 and saves the GUI into a second frame buffer 320. It is understood that the frame buffer is a video output device that drives a video display from a memory buffer containing a complete frame of the video.

In block S13, the combination module 330 combines the video from the first frame buffer 310 and the GUI from the second frame buffer 320 to generate a combined video and sends the combined video to the display device 40. In one embodiment, the combined video is generated by a method of alpha blending.

By having the GUI generated by a GUI circuit 20 then sending the generated GUI signal to the SOC 30, overworking of the SOC 30 is prevented and the system employing the GUI circuit 20 and the SOC 30 will be more stable.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system on chip (SOC), comprising:
a storage system;
at least one processor; and
one or more programs stored in the storage system and being executable by the at least one processor, the one or more programs comprising:
a video acquiring module operable to receive a video from a video input device and a GUI from a GUI circuit, and save the video into a first frame buffer of the SOC and the GUI into a second frame buffer of the SOC; and
a combination module operable to combine the video from the first frame buffer and the GUI from the second frame buffer to generate a combined video and send the combined video to a display device.

2. The system of claim 1, wherein the video input device is selected from the group consisting of a portable media player, a digital versatile disc (DVD) player, and a cable television connection.

3. The system of claim 1, wherein the GUI circuit is an application specific integrated circuit (ASIC).

4. The system of claim 1, wherein the combined video is generated by a method of alpha blending.

5. A computer-based method for displaying a graphical user interface (GUI) in a video, the method comprising:
receiving the video from a video input device and the GUI from a GUI circuit, and save the video into a first frame buffer of a system on chip (SOC) and the GUI into a second frame buffer of the SOC; and
combining the video from the first frame buffer and the GUI from the second frame buffer to generate a combined video and send the combined video to a display device.

6. The method of claim 5, wherein the video input device is selected from the group consisting of a portable media player, a digital versatile disc (DVD) player, and a cable television connection.

7. The method of claim 5, wherein the GUI circuit is an application specific integrated circuit (ASIC).

8. The method of claim 5, wherein the combined video is generated by a method of alpha blending.

9. A non-transitory computer-readable medium having stored thereon instructions that, when executed by a computing device, causing the computing device to perform a method for displaying a graphical user interface (GUI) in a video, the method comprising:
receiving the video from a video input device and the GUI from a GUI circuit, and save the video into a first frame buffer of a system on chip (SOC) and the GUI into a second frame buffer of the SOC; and
combining the video from the first frame buffer and the GUI from the second frame buffer to generate a combined video and send the combined video to a display device.

10. The medium of claim 9, wherein the video input device is selected from the group consisting of a portable media player, a digital versatile disc (DVD) player, and a cable television connection.

11. The medium of claim 9, wherein the GUI circuit is an application specific integrated circuit (ASIC).

12. The medium of claim 9, wherein the combined video is generated by a method of alpha blending.
